(19) United States
(12) Patent Application Publication
(10) Pub. No.: US 2026/0141544 A1
(43) Pub. Date: May 21, 2026

(54) REGISTRATION OF MICROSCOPE IMAGES WITH SPECIFIC CONTRASTS

(71) Applicant: Carl Zeiss Microscopy GmbH, Jena (DE)

(72) Inventors: Lars LÖTGERING, Jena (DE); Markus STICKER, Jena (DE); Helmut LIPPERT, Jena (DE)

(21) Appl. No.: 19/392,442

(22) Filed: Nov. 18, 2025

(30) Foreign Application Priority Data
Nov. 19, 2024 (DE) 10 2024 133 850.4

(51) Int. Cl. G06T 7/33; G06T 7/38

(52) U.S. Cl. CPC G06T 7/337; G06T 7/38; G06T 2207/10016; G06T 2207/10056; G06T 2207/10064; G06T 2207/20084; G06T 2207/20221

(57) ABSTRACT

Techniques for registering a first microscope image with a second microscope image are described. The first microscope image images a sample with a first specific contrast and the second microscope image images the sample with the first specific contrast or a second specific contrast. For the registration, a reference microscope image is used, which images the sample with a non-specific contrast.

### CROSS REFERENCE TO RELATED APPLICATION

This application claims priority to German patent application No. 10 2024 133 850.4, filed Nov. 19, 2024; this German patent application is incorporated herein by reference.

### TECHNICAL FIELD

Various examples of the disclosure relate to techniques for registering two microscope images having specific contrasts.

### BACKGROUND

In biology, light microscopy with fluorescence contrast is of great importance, since it enables molecular-specific insights into cells and tissue sections by means of fluorescence markers. The co-localization and quantification of fluorescence concentrations are especially of interest, since they can provide information about temporary progressions of diseases and the treatment thereof with pharmaceuticals. Corresponding information can also be obtained by means of other specific contrasts that selectively stain specific molecular or cellular structures. A further example of a common specific contrast without fluorescent labels is haematoxylin and eosin (H&E) staining.

Nowadays, fluorescent dyes can be selected virtually freely in terms of their spectral dye properties. For example, primary antibody-based markers are available that can be specifically adapted to tissue types and organelles. Flexibly selectable secondary dyes can be bound thereto or in the immediate environment, so that users can assign the spectral characteristics of the measured fluorescence signals in a targeted manner.

In fluorescence microscopes, selected fluorescent dyes can be caused to emit light using characteristic excitation signatures or at characteristic excitation wavelengths. The corresponding microscope images thus have a fluorescence contrast. Fluorescence, typically emitted at longer wavelengths, can then be separated from the excitation light using specifically selected colour filters. With a suitable combination of different colour spectra in the excitation light, and also a suitable selection of specific colour filters in the detection arm of the microscope, a plurality of fluorescence contrasts and/or brightfield contrasts can be recorded sequentially or in parallel or in a temporal context. For example, a multi-channel recording can be obtained in which a plurality of microscope images are captured consecutively with different contrasts, but no or only as few optical elements as possible are exchanged between the capture of the individual microscope images of the multi-channel recording. In general, a plurality of microscope images of the sample with different fluorescence contrasts are thus obtained. The different fluorescence contrasts specifically mark different structures of the sample. Exemplary samples examined are cell samples or tissue section samples (e.g. in histopathology).

It has been observed that microscope images with different specific contrasts (the different microscope images nay be stained with different fluorescent labels or different non-fluorescent labels, for example H & E) often have different appearances. One example is shown in FIG. 1. FIG. 1 illustrates a microscope image 91, which images a cell sample with a first fluorescence contrast; and also a microscope image 92, which images the same cell sample with a second fluorescence contrast, which is different from the first fluorescence contrast. Both the microscope image 91 and the microscope image 92 are obtained by a respective tile scan. It is conceivable, in particular, for the microscope image 91 and the microscope image 92 to be captured by a common tile scan, wherein for each tile a corresponding multi-channel recording with the two fluorescence contrasts from different channels is captured before the next scan step is performed.

The two fluorescence contrasts specifically mark different cell structure types, so that the structures that are visible particularly well in the microscope image 91 are different from the structures that are visible particularly well in the microscope image 92. This becomes visible particularly well from the superimposed image 95 (corresponds to a superimposition of the microscope image 91 with the microscope image 92).

However, the different appearances of the two microscope images 91, 92 do not necessarily result solely from the use of different fluorescence contrasts or more generally different specific contrasts. This is because it is possible for the image planes of the two microscope images 91, 92 to be displaced relative to one another. That means that there is a systematic offset in the lateral (xy-direction) or axial (z-direction) direction. A different appearance may result not only from a lateral offset, but also from a different distortion and/or rotation, etc. of the microscope images with respect to one another.

There are various reasons that may cause such displacement and/or distortion and/or rotation of the image planes. Different microscope images with different specific contrasts are generally captured using different optical channels. Different optical channels have different optical beam paths. For example, it is a practical problem in the recording of microscope images with fluorescence contrast that the colour filters in the detection arm lead to a lateral displacement of the microscope images with different fluorescence contrasts with respect to one another in the image plane on account of misalignment. This can even be the case (although then typically less pronounced) when the different microscope images are part of the same multi-channel recording. A further reason for the lateral offset of the channels with different contrasts may be that a so-called “tile scan” is recorded per channel and the tile positions were not reached exactly again in successive tile scans. These tiles are then combined to form a mosaic image, sometimes referred to as “stitching”. Yet another reason may be that the microscope has a plurality of recording sensors (e.g. cameras) that image slightly different sample regions with slightly different optical optics. This means that a plurality of optical channels are used. In this context, it is also conceivable to use a plurality of microscopes with different optical properties for recording individual fluorescence channels. Besides the lateral offset (xy-plane), an axial offset (z-direction) of different fluorescence channels can also occur, e.g. on account of longitudinal chromatic aberrations of the optical system. Likewise, a relative rotation of images is possible if they have been recorded on different microscopes or by means of different cameras. It would also be conceivable for the sample to be manipulated between the capture of the microscope images, i.e. e.g. stained or destained, in order e.g. to make specific structures visible one after another without causing interference between the fluorescence signals.

In order to enable a reliable evaluation of the information contained in the microscope images 91, 92, it is often desirable, in view of the possible displacement, rotation and/or distortion of the image planes, to carry out an image registration between the microscope image 91 and the microscope image 92. This registration quantifies or compensates for such displacement and/or distortion and/or rotation, for example by identifying common image features in the microscope images. Therefore, such an image registration enables for example only the evaluation of cell-biological properties of cell samples which can be derived from a comparison of the two microscope images 91, 92.

However, it has been observed that carrying out a direct image registration between the microscope image 91 and the microscope image 92, or generally between microscope images with different fluorescence contrasts, does not provide reliable results.

The prior art therefore discloses approaches for carrying out a corresponding registration between microscope images 91, 92 indirectly or using aids. For example, it is possible to capture a further microscope image with a further fluorescence contrast, which marks similar cell structure types. However, a registration by way of an additional staining has major disadvantages: A reference fluorescence staining bleaches upon prolonged exposure. Ideally, it would be desirable to use a method in which the sample can be fully referenced without bleaching the reference channel and indeed also the other fluorescence channels. In case of increased bleaching, the referencing of the sample would be lost, making repeated measurements and long-term experiments impossible. In addition, a reference staining can lead to degradation of the quality of the fluorescence channels that are actually of interest. For example, an additional fluorescence staining can lead to spectral overlap with other channels, resulting in computationally complex spectral separation. Moreover, a reference staining may outshine weakly emitting regions of the stainings of interest. The microscope has to be equipped with additional excitation wavelengths (e.g. additional colour LEDs or laser diodes) and also additional colour filters/beam splitters on the hardware side. The sample itself requires an additional dye. Overall, this leads to higher costs in the production of the system and sample. On account of the low fluorescence yield (ratio of fluorescence emission to excitation radiation), the acquisition of fluorescence channels is typically longer than of transmitted light modalities such as e.g. brightfield. An additional fluorescence channel thus leads to a noticeable increase in the acquisition time in the experiment.

A further technique is known from US 2012/0257811. The latter discloses the registration of two microscope images with fluorescence contrast with the aid of a brightfield image as reference. Such a technique has the disadvantage that some structures in the brightfield image are not visible or are only weakly visible.

Yet another technique is known from WO 2023/044071 A1. The latter describes how a first image of a biological sample on a first substrate is obtained and a second image of the biological sample on a second substrate is obtained. The second substrate has one or more spatial reference points. A registration for the first image and the second image can then be determined, the registration being carried out using patterns in the two images. This registration can then be used to overlay the first image on a spatial data set comprising spatial analysis data, a reference system of the spatial data set being known with respect to the second image on the basis of the spatial reference points. Such techniques have the disadvantage that specific transparent substrates have to be used in combination with spatial reference points (referred to as fiducials). That is relatively costly and complex. Prior knowledge about the appearance of the spatial reference points in the microscope images has to be available. Corresponding markings have to be found using a suitable image processing algorithm.

### SUMMARY

There is thus a need for improved techniques for determining registration parameter values for the registration of microscope images that images structures of a sample with specific contrasts.

This object is achieved by the features of the independent patent claims. The features of the dependent claims define embodiments.

By means of the techniques described herein, it is possible for channels with specific contrast—especially those which mark completely complementary structures of a sample, i.e. have different specific contrasts—to be unambiguously aligned with one another, e.g. registered two-dimensionally (2-D) or three-dimensionally (3-D).

The corresponding microscope images can be part of a common multi-channel recording. For example, the microscope image can be tile images at a specific tile position of a tile scan. A corresponding multi-channel recording can be captured at each tile position.

However, it would also be conceivable for the microscope images to be part of different multi-channel recordings. For example, the microscope images can be tile images at adjacent tile positions of a common tile scan, wherein different multi-channel recordings are captured at the different tile positions.

It would also be conceivable for the sample to have been manipulated between capture of the corresponding microscope images, i.e. e.g. stained and/or destained in a staining cycle. In such a case, the microscope images can be e.g. mosaic images, each composed of a plurality of tiles.

The techniques described herein can be used e.g. to recover specific regions of interest (ROIs) in samples captured with different imaging modalities and/or at different microscope magnifications. The techniques described herein can be used to effect reliable stitching of microscope images: that means that a plurality of smaller, overlapping tile images of a sample can be merged to form a larger mosaic image. The techniques described herein do not require a reference staining or substrate-based fiducials/landmarks/reference points. The techniques described herein enable a particularly accurate registration between microscope images having different fluorescence contrasts/different specific contrasts. In particular, the techniques described herein are also robust vis-à-vis displacements, distortions or rotations of the image planes of the two microscope images with respect to one another.

A computer-implemented method is disclosed. The method is used to register a first microscope image with a second microscope image. The first microscope image images a sample with a first specific contrast and the second microscope image images the same sample with either the first specific contrast or else another, second specific contrast.

For example, the sample can be a cell sample or a tissue section sample. The sample can contain cell structures.

For example, the first specific contrast specifically marks at least one first cell structure type. The second specific contrast specifically marks at least one second cell structure type. The at least one first cell structure type is for example at least partially different from the at least one second cell structure type. In other words, that means therefore that the first specific contrast marks at least one cell structure type that is not marked identically by the second specific contrast. An overlap in the markings between the different specific contrasts is possible, even if the first specific contrast is different from the second specific contrast.

For example, the first specific contrast can be a specific fluorescence contrast or can be obtained by non-fluorescent labels (e.g. H&E).

The second specific contrast can be a specific fluorescence contrast or can be obtained by non-fluorescent labels (e.g. H&E).

The first microscope image and the second microscope image can overlap completely or can have at least one overlap region, that is to say at least partially image the same region of the sample.

The first microscope image can be a tile image or a mosaic image.

The second microscope image can correspondingly be a tile image or a mosaic image.

If the first microscope image is a tile image and the second microscope image is a tile image, these can be captured at the same tile position of a common tile scan or at different tile positions of the common tile scan. It would also be conceivable for the first microscope image to be part of a first tile scan and the second tile image to be part of another, second tile scan, which are optionally associated with different staining cycles of the sample. The first microscope image and the second microscope image can be captured at the corresponding tile positions of the two tile scans.

The method comprises obtaining a reference microscope image, which images the sample with a non-specific contrast. In addition, the method comprises carrying out the registration of the first microscope image with the second microscope image using the reference microscope image.

The reference microscope image can be a mosaic image (if the first and second microscope images are mosaic images). However, the reference microscope image can also be a tile image (if the first and second microscope images are tile images).

For example, a tile scan could be carried out that captures in each case one or more microscope images and an associated reference microscope image at a plurality of tile positions. For example, the first microscope image, the second microscope image and the reference microscope image can all be captured at the same tile position and be part of a common multi-channel recording.

The non-specific contrast should be distinguished from the first specific contrast and the second specific contrast. The non-specific contrast does not mark specific molecular or cellular structures-unlike the first and second specific contrasts. Typically, no staining of the sample is required to obtain the non-specific contrast. The non-specific contrast can be a label-free contrast.

For example, the non-specific contrast can be selected from the following group: phase-like contrast; phase contrast; brightfield contrast; contrast as a result of oblique illumination; darkfield contrast; autofluorescence contrast.

By virtue of the reference microscope image having the non-specific contrast, for example, the different marked cell structure types from both the first microscope image and the second microscope image can be visible in the reference microscope image, so that the registration of the first microscope image with the reference microscope image and the second microscope image with the aid of the reference microscope image is robust and reliably possible on the basis of image features. The fact that the reference microscope image has no fluorescence contrast additionally results in a reduction in light exposure of the cell sample. The exposure of the cells to the fluorescent dye is reduced, thus reducing the influence of the measurement on cell biology. For example, carrying out the registration can comprise applying a multimodal registration algorithm. In particular, the multimodal registration algorithm can be applied between microscope images with different contrasts.

For example, the multimodal registration algorithm can be applied between a microscope image with specific contrast and a (reference) microscope image with non-specific contrast.

For example, the multimodal registration algorithm can be applied between different tile images of a tile scan that have an overlap. It would also be possible to carry out the multimodal registration algorithm between tile images of different (i.e. sequential) tile scans.

For example, the first microscope image can be associated with a first staining cycle of the sample. For example, the first staining cycle can stain the sample with at least one non-fluorescent label. This non-fluorescent label can define the first specific contrast of the first microscope image. For example, H&E could be used as a non-fluorescent label. However, it would also be conceivable for the first staining cycle to stain the sample with a fluorescent label.

The second microscope image can be associated with a second staining cycle of the sample. For example, the second staining cycle can stain the sample with at least one non-fluorescent label. This non-fluorescent label can define the second specific contrast of the second microscope image. For example, H&E could be used as a non-fluorescent label. The second staining cycle can stain the sample with one or more fluorescent labels. For example, exclusively fluorescent labels could be used in the second staining cycle, i.e. no non-fluorescent labels as in the first staining cycle. One of the one or more fluorescent labels from the second staining cycle can define the second specific contrast of the second microscope image.

If different fluorescence contrasts, i.e. a plurality of different fluorescent labels, are used in the second staining cycle, then a multi-channel recording can be effected which captures respective different fluorescence contrasts at different wavelengths.

For example, the second staining cycle can be carried out after the first staining cycle.

The reference microscope image can then be associated with the first staining cycle of the sample. That means, therefore, that the reference microscope image is captured for example together with the first microscope image as a multi-channel recording. For example, it would be conceivable for the first microscope image and the reference microscope image each to be mosaic images from a common tile scan.

The reference microscope image can be captured before the second staining cycle is carried out.

In some examples, the method additionally comprises obtaining a further reference microscope image. The further reference microscope image can image the sample with the same and specific contrast with which the reference microscope image also images the sample. However, it would also be conceivable for the further reference microscope image to use a different non-specific contrast from that of the reference microscope image.

The further reference microscope image can be associated with the second staining cycle. For example, the further reference microscope image can be captured together with the second microscope image as a multi-channel recording. For example, it would be conceivable for the second microscope image and the further reference microscope image each to be mosaic images from a common tile scan.

That means, therefore, that in one variant two reference microscope images with a non-specific contrast are present. It is then possible to compare or align the first microscope image with the reference microscope image; in addition, the second microscope image can be compared or aligned with the further reference microscope image. Furthermore, a comparison or an alignment of the reference microscope image with the further reference microscope image can be effected.

However, such a comparison between the first microscope image and the reference microscope image and between the second microscope image and the further reference microscope image is optional. It would be conceivable for the first microscope image to already be inherently registered with the reference microscope image; and/or for the second microscope image to already be inherently registered with the further reference microscope image. For example, if the first microscope image and the reference microscope image are recorded as part of a common multi-channel recording or sequentially, then it may be that the microscope was able to record exactly the same section again (e.g. if the stage was not moved between the recordings and also beam splitter/filter changes did not cause an offset between the images). Only the reference microscope image is then compared with the further reference image of the next staining cycle or with the second microscope image (if a further reference microscope image is not present).

Various disclosed techniques are based on the insight that typically the differences in the imaging of the sample between the first microscope image and the reference microscope image on the one hand and between the second microscope image and the further reference microscope image on the other hand are relatively small. This is because these image pairs are each associated with the same staining cycle and for example can be captured as part of a common multi-channel recording and in particular by means of common tile scans.

For example, it would be conceivable for the first microscope image to be a first mosaic image, which is composed of first tile images. The second microscope image can be a second mosaic image, which is composed of second tile images. In particular, the first tile images and the second tile images can be captured in different tile scans because they are associated with different staining rounds. The multimodal registration algorithm can then be carried out between the first tile images and respective reference tile images of the reference microscope image; and again between the second tile images and respective further reference tile images of the further reference microscope image. For example, reference tile images can be present for each tile position of the respective tile scan. In other words, that means, therefore, that the multimodal registration algorithm is applied twice, namely once for the first tile scan (which captures the first tile images and the respective reference tile images) and once for the second tile scan (which captures the second tile images and the respective further reference tile images). The multimodal registration algorithm can thus be applied at the tile hierarchical level.

Once again it is not necessary in all variants to carry out a comparison between the first tile images and the respective reference tile images and/or between the second tile images and the respective further reference tile images. This is the case if the corresponding image pairs are already inherently registered.

Regardless of whether a multimodal registration algorithm is applied at the tile level or whether the different tile images are already inherently registered at the tile level, it would be conceivable for carrying out the registration to comprise applying a unimodal registration algorithm. The unimodal registration algorithm can be applied between the reference microscope image and the further reference microscope image (i.e. after stitching at the mosaic level).

However, it would also be conceivable to carry out the stitching only after applying the unimodal registration algorithm. In such a case, for example, the registration parameter values of the two multimodal registration algorithms can be combined with the registration parameter values of the unimodal registration algorithm in order to register each respective tile of the first tile scan with each respective tile of the second tile scan for the specific contrasts.

For example, carrying out the registration of the first microscope image and the second microscope image can comprise: determining registration parameter values for the registration on the basis of a comparison of the second microscope image with the reference microscope image. At the same time, it would be conceivable for the first microscope image and the reference microscope image to already be inherently registered-hence no comparison between the first microscope image and the reference microscope image is required. This is useful for example if the second microscope image and the reference microscope image are not captured in a temporal context, i.e. for example are not part of the same multi-channel recording or are not part of the same tile scan. For example, the first microscope image and the second microscope image can be associated with different staining cycles. In addition, this is useful if the first microscope image and the second microscope image are captured by means of significantly different optical channels, for example by means of optical channels having different objectives.

An optical channel generally describes the optical imaging specification from the object space into the image space. The optical channel thus describes the optical imaging of the sample onto a camera of the microscope. The optical channel is determined by the optical components used, such as for example objective, filter, etc.

A plurality of microscope images can jointly be part of a multi-channel recording. That means that the plurality of microscope images are captured in a temporal context and that as many optical components as possible remain unchanged between the capture of the microscope images of the multi-channel recording. For example, between the capture of different microscope images of a multi-channel recording, just colour filters can be inserted into the beam path or removed.

In general, registration parameter values can indicate e.g. displacement in the x-direction, displacement in the y-direction, rotation, scaling and/or shearing, or deformation, distortion, compression, etc. between two images.

If the first microscope image and the reference microscope image are part of the same multi-channel recording, typically the optical channels used are very similar and the sample is not manipulated between the capture of the first microscope image and the reference microscope image (i.e. the first microscope image and the reference microscope image are captured in a narrow temporal context). In particular, it may be possible—as already explained above—for the first microscope image and the reference microscope image, if these are part of the same multi-channel recording, to be inherently registered: that is to say that the registration parameter values indicate an identity mapping or are at least static and previously known. It may then be unnecessary to determine corresponding registration parameter values by comparing the first microscope image with the reference microscope image. By determining the registration parameter values by comparing the second microscope image with the reference microscope image, then the first microscope image and the second microscope image are directly also registered with one another.

Sometimes it may happen, however, that—although the first microscope image and the reference microscope image are part of the same multi-channel recording—no inherent registration is present. For example, chromatic aberrations in different colour filters used to select different wavelengths can cause displacement, distortion, etc. of the two microscope images with respect to one another. A multimodal registration algorithm can then be used—for example as described above.

However, it would also be conceivable for the reference microscope image and the first microscope image not to be part of the same multi-channel recording. For example, the reference microscope image and the first microscope image can be captured at different times or in regard to completely different optical channels. For example, the reference microscope image and the first microscope image can be associated with different tile scans. In such a case, in particular, further registration parameter values for the registration can be determined on the basis of a comparison of the first microscope image with the reference microscope image (for example by applying a multimodal registration algorithm). By this means and by determining the registration parameter values by comparing the second microscope image with the reference microscope image, then the first microscope image and the second microscope image are registered with one another. For example, the registration parameter values and the further registration parameters could then be combined with one another (without once again having to give consideration to image features) in order to obtain an imaging specification that specifies the final registration between the first microscope image and the second microscope image, so-called “result registration parameter values”.

A description has been given above of examples in which a comparison (for determining registration parameter values) is carried out between at least one microscope image with specific contrast and a reference microscope image with non-specific contrast. In some examples, it would be conceivable for such a comparison to be carried out also or exclusively between two reference microscope images with the non-specific contrast. For example, it would be conceivable for registration parameter values for the registration between the first microscope image and the second microscope image to be determined on the basis of a comparison of a reference microscope image and a further reference microscope image, which also images the sample with the non-specific contrast.

For example, it would be conceivable for the reference microscope image and the first microscope image to be part of the same multi-channel recording; and the further reference microscope image and the second microscope image to be part of the same (other) multi-channel recording. On the other hand, however, the two reference microscope images can be captured at different times, for example after sample processing for instance in the context of a staining cycle, and/or with different optical channels, for example especially with different microscopes. The two reference microscope images can thus be part of different multi-channel recordings. Accordingly, the first microscope image and the second microscope image would be part of different multi-channel recordings. In a situation in which the different microscope images of a specific multi-channel recording are inherently registered, it would be unnecessary to carry out a further comparison of the first microscope image with the reference microscope image (because these two microscope images are already inherently registered); in addition, it would be unnecessary to carry out a further comparison of the second microscope image with the further reference microscope image (because these two microscope images are also already inherently registered). In other words, that means, therefore, that by determining the registration parameter values on the basis of the comparison of the two reference microscope images, the registration between the first and second microscope images is already obtained.

If a plurality of reference microscope images are present, they can have the same non-specific contrast, e.g. a particular digital phase contrast.

In one variant, further registration parameter values are determined by a comparison of the reference microscope image with the first microscope image and/or even further registration parameter values are determined by a comparison of the further reference microscope image with the second microscope image. Such a scenario is useful for example if the reference microscope image and the first microscope image are not captured with the same optical channel and/or are not captured in a temporal context, i.e. in particular are not part of the same multi-channel recording (the same applies to the further reference microscope image and the second microscope image). In addition, such a further determination of registration parameter values can be useful if chromatic aberrations are present in an optical channel used for capturing the respective pair of reference microscope image and microscope image of the same multi-channel recording.

For example, the non-specific contrast of the reference microscope image could be a phase-like contrast. A phase-like contrast can be e.g. a phase contrast. Examples include e.g. a Zernike phase contrast, a Normarski phase contrast. In this case, specific optical elements are used in the beam path of the light, e.g. a phase ring in the objective and a ring stop in the condenser lens. Interference between the background and object light can be rendered visible in this way. The image contrast can be increased by using a phase contrast. That means that the cell structures are visible particularly well. Cells are phase objects that do not cause any reduction, or any significant reduction, in the amplitude of the light when the latter passes through the cell sample, and so the phase contrast is preferred for rendering the phase shift visible.

However, a digital phase contrast can also be used as phase-like contrast. A plurality of images are recorded here, and are then computationally combined to form a single phase contrast image. Therefore, such techniques may be referred to as digital phase contrast. The phase contrast is obtained by digital post-processing of the intensity images recorded. Examples include the transport of intensity equation (TIE) and the differential phase contrast (DPC). TIE is described in: Streibl, Norbert. “Phase imaging by the transport equation of intensity.” Optics communications 49.1 (1984): 6-10. DPC is described in: Mehta, Shalin B., and Colin JR Sheppard. “Quantitative phase-gradient imaging at high resolution with asymmetric illumination-based differential phase contrast.” Optics letters 34.13 (2009): 1924-1926. To record a TIE data set, the sample is displaced along the optical axis (z-direction), i.e. displaced axially, and what is known as a z-stack, consisting of at least two images, is recorded. The data are then combined by calculation, whereby a phase contrast image is obtained. For this purpose, a diffusion-type partial differential equation is solved. In DPC, the sample is illuminated from at least two different directions (oblique illumination) while the sample remains at a fixed z-position. All types of segmented sources are possible sources for the oblique illumination; examples include segmented diodes, light-emitting diode arrays, digital micromirror devices (DMDs), liquid crystal displays (LCDs or SLMs) or variable condenser stops. The data recorded are subsequently converted into a phase contrast image by solving a deconvolution problem. Combinations of TIE and DPC would also be conceivable, e.g. as described in European Patent Application 24 184 623.7 dated 26 Jun. 2024. The use of a digital phase contrast (as opposed to a hardware-based phase contrast) has the advantage that there is no need for complex insertion or removal of objects into/from the beam path of the light when capturing the digital phase contrast. Rather, the illumination can be varied in a targeted manner, for example by means of a switchable light-emitting diode array arranged in the illumination pupil plane. This can be implemented quickly and easily.

However, it would also be conceivable for the phase-like contrast to be a digital phase gradient contrast. For example, corresponding techniques for various oblique illuminations are described in DE 10 2015 208 084 A1. Intensity images of the cell sample from different illumination directions are captured and then a difference between the intensity images is calculated. For example, a normalized difference can be calculated. Such a phase gradient contrast is particularly easy to calculate. For example, there is no need for deconvolution.

For example, a first temporary reference microscope image and a second temporary reference microscope image can be obtained. The first temporary reference microscope image and the second temporary reference microscope image can both image the cell culture with the same intensity contrast but in conjunction with different defocus values and/or illumination geometries. The reference microscope image can then be determined on the basis of pixelwise difference formation between the first temporary reference microscope image and the second temporary reference microscope image. Optionally, a normalization could be performed. A phase gradient contrast can be generated on the basis of such microscope images with intensity contrast captured in conjunction with different defocus values and/or illumination geometries. The pixelwise difference formation between the two temporary reference microscope images is a simple computational operation that can be carried out particularly quickly without requiring large computational resources. Therefore, corresponding techniques are especially suitable for real-time or near-real-time registration as well.

For example, specific registration parameter values of an affine transformation between a corresponding image pair can be determined by means of the techniques described herein. An affine transformation includes translation, rotation, scaling and shearing in matrix form. However, non-linear deformations using an elastic registration algorithm would also be conceivable. If an elastic registration algorithm is used, it would be conceivable for example for the cell sample to have experienced a change between the capture of the different microscope images, said change being manifested in different forms of the individual cells. Such changes in the structure geometries can be taken into account by way of corresponding distortions or deformations in the context of an elastic registration algorithm.

As already described, a multimodal registration algorithm can be used in various examples. Such a multimodal registration algorithm is robust vis-à-vis an inversion of the brightness histogram between the microscope images compared with one another. This is especially useful if a reference microscope image with a non-specific contrast (for example a phase-like contrast) is compared with a microscope image with specific contrast (for example a fluorescence contrast or a H&E contrast).

For example, a registration algorithm selected from the following group could be used: mutual information; normalized gradient field; structural similarity index; segmentation-based similarity measure; feature detection; and artificial neural network. A multimodal registration algorithm that uses for example one of the similarity measures as explained above enables the first microscope image or the second microscope image (each with a specific contrast, e.g. a fluorescence contrast) to be compared with the reference microscope image (with a non-specific contrast, e.g. without fluorescence contrast, but with phase-like contrast). Typically, in a fluorescence contrast, specific parts of cells of a corresponding sample appear particularly bright. However, since cells are phase objects that do not cause significant damping of the amplitude of the transmitted light, it may happen that in the reference microscope image the same parts of the cells appear darker vis-à-vis the background. In a multimodal registration algorithm, such an inversion of the brightness histogram can be taken into account.

A landmark-based registration algorithm could also be used. In a landmark-based registration algorithm, specific characteristic landmarks, that is to say characteristic structures or patterns that appear in both images, are sought by means of a suitable object recognition algorithm. For example, predefined structures could be sought, that is to say structures whose presence is expected in the images and for which there is some prior knowledge regarding their appearance in the images. However, it would also be conceivable to use an object recognition algorithm that does not include any specifications about the type of structures to be sought. Such a landmark-based registration algorithm can also be particularly robust vis-à-vis changes in the brightness values. This is owing to the fact that it focuses less on the brightness of the different pixels, but more on specific real-space patterns.

An electronic data processing device is described. The electronic data processing device is used to register a first microscope image with a second microscope image. The electronic data processing device comprises a processor and a memory, wherein the processor is configured to load program code from the memory and execute it. When the program code is executed, the processor executes the steps of a method as described above.

The features set out above and features described below can be used not only in the corresponding combinations explicitly set out, but also in further combinations or in isolation, without departing from the scope of protection of the present invention.

### BRIEF DESCRIPTION OF THE FIGURES

FIG. 1 illustrates a first microscope image with a first fluorescence contrast and a second microscope image with a second fluorescence contrast and a superimposition of the first microscope image with the second microscope image.

FIG. 2 illustrates a phase contrast image for the cell sample from FIG. 1.

FIG. 3 is a flowchart of one exemplary method.

FIG. 4 is a flowchart of one exemplary method.

FIG. 5 illustrates a distance functional of an NGF registration algorithm according to various examples.

FIG. 6 schematically illustrates the registration between two microscope images with different specific contrasts according to various examples.

FIG. 7 schematically illustrates the registration between two microscope images with different specific contrasts according to various examples.

FIG. 8 schematically illustrates the registration between two microscope images with different specific contrasts according to various examples.

FIG. 9 schematically illustrates a tile-to-tile registration and a scan-to-scan registration according to various examples.

FIG. 10 schematically illustrates a system having a data processing device and a data source according to various examples.

### DETAILED DESCRIPTION

The above-described properties, features and advantages of this invention and the way in which they are achieved will become clearer and more clearly understood in association with the following description of the exemplary embodiments which are explained in greater detail in association with the drawings.

The present invention is explained in greater detail below on the basis of preferred embodiments with reference to the drawings. In the figures, identical reference signs designate identical or similar elements. The figures are schematic representations of various embodiments of the invention. Elements illustrated in the figures are not necessarily illustrated as true to scale. Rather, the various elements illustrated in the figures are rendered in such a way that their function and general purpose become comprehensible to the person skilled in the art. Connections and couplings between functional units and elements illustrated in the figures can also be implemented as an indirect connection or coupling. A connection or coupling can be implemented in a wired or wireless manner. Functional units can be implemented as hardware, software or a combination of hardware and software.

Techniques for registering two microscope images are disclosed below. The two microscope images can have different specific contrasts; however, it would also be conceivable for the two microscope images to have the same specific contrast. The two microscope images can be part of a common multi-channel recording or can be part of different multi-channel recordings. The two microscope images can each be a mosaic image or can each be a tile image. The two microscope images can be associated with different tile scans or with the same tile scan.

In the various examples, no direct registration between the two microscope images is ascertained on the basis of an image comparison; rather, one or more “auxiliary registrations” are determined on the basis of one or more reference microscope images, which, for example, have a non-specific contrast. The two microscope images can then be represented as different fluorescence channels in a microscope image.

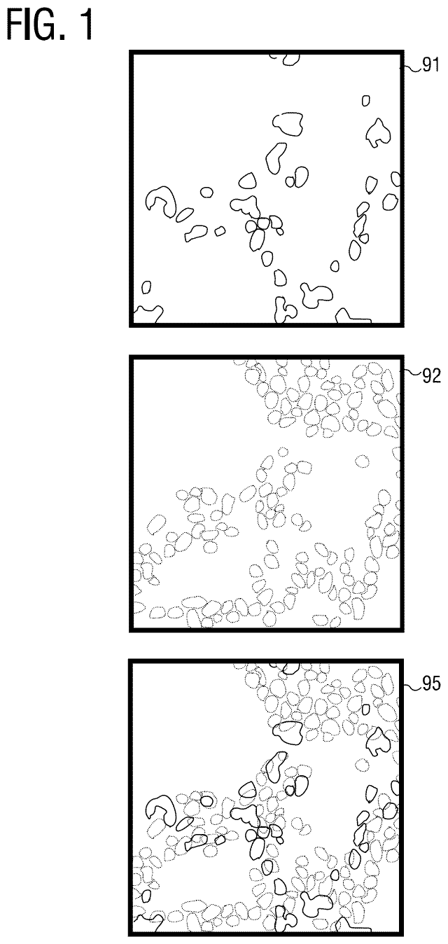

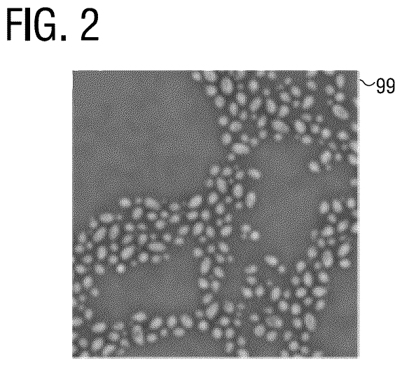

By way of example, in connection with FIG. 1 that showed the microscope image 91 with the first fluorescence contrast (as an example of a first non-specific contrast); and the microscope image 92 with the second fluorescence contrast (as an example of a second non-specific contrast). The associated reference microscope image 99 with a phase contrast is shown in FIG. 2. There, the different cell structure types are all visible together. The two microscope images 91, 92 are possibly laterally displaced with respect to one another, or even non-linearly deformed and/or rotated. Such and other registration parameters can be quantified as part of the registration in order to enable a more extensive evaluation.

In one exemplary variant, the microscope images 91, 92 are firstly each individually aligned with the reference microscope image 99 by means of a corresponding multimodal registration. Initially, the microscope images 91, 92 are displaced and/or rotated and/or otherwise distorted relative to the reference microscope image 99. If multimodal registration is successful, all the microscope images 91, 92, 99 are aligned both axially and laterally with respect to one another. Possible rotation errors etc. are likewise rectified.

The registration of the microscope images 91, 92 with respect to the reference microscope image 99 can be captured on a sample after a multi-channel recording (in which both microscope images 91, 92 are captured simultaneously or at least rapidly in succession; i.e. both microscope images 91, 92 are part of the same multi-channel recording) and also in the course of a renewed multi-channel recording after an interim sample treatment, such as e.g. cyclic staining (staining cycle) of the sample. In this case, a repeated recording of the reference microscope image can be effected in the course of the renewed multi-channel recording, which image in turn can be used for alignment with both the phase contrast image of the first staining round and the fluorescence channels of this and/or further staining rounds. That then means, therefore, that a plurality of multi-channel recordings each have a respective reference microscope image. For example, each of the multi-channel recordings can be captured by means of a tile scan. It can also be expedient to use an elastic image registration, e.g. if the sample has deformed on account of mechanical influencing during the imaging steps.

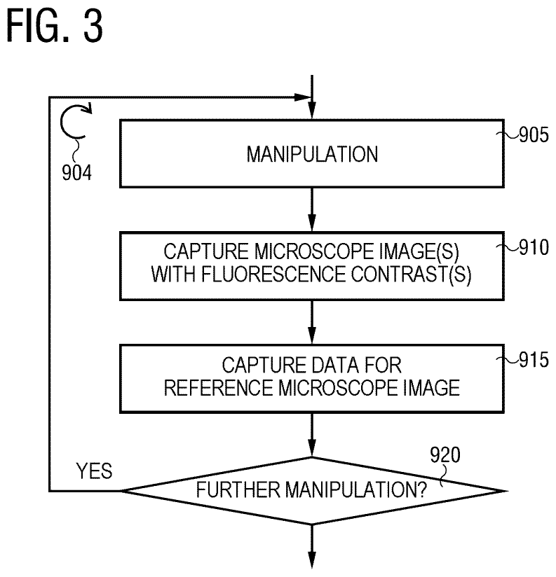

FIG. 3 is a flowchart of one exemplary method. The method from FIG. 3 can be carried out by an electronic data processing device. By way of example, the method from FIG. 3 can be executed by a processor when the latter loads program code from a memory and executes it. The method from FIG. 3 is thus computer-implemented.

The method from FIG. 3 is used to capture microscope images and one or more reference microscope images. The reference microscope images have a non-specific contrast, for example a phase-like contrast.

The microscope images have different specific contrasts, for example different fluorescence contrasts. For example, different dyes and/or different wavelengths can be used for fluorescence excitation. Different labels can be used.

The microscope images with the different specific contrasts can be captured in one or more “staining cycles”, that is to say successive iterations 904, in each of which in box 905 a sample is stained with a corresponding (e.g. fluorescent) dye or label and/or a specific dye or label is removed. By way of example, for each iteration 904, a plurality of microscope images could be captured for a multi-channel recording; i.e. different iterations correspond to different multi-channel recordings. For each iteration 904, a respective tile scan could be carried out in which e.g. a multi-channel tile image is captured per tile (i.e. at each tile position).

In box 905, the sample is manipulated, i.e. e.g. stained. For example, the sample can be stained with one or more dyes. The different dyes specifically mark particular cell structure types, e.g. with one or more fluorescent labels and/or with one or more non-fluorescent labels. For example, a first dye could mark/label organelles, while another dye marks/labels the cell membrane or the cell nucleus. Different fluorescent dyes can be excited by light at different wavelengths and/or can fluoresce at different wavelengths.

Manipulations other than staining would also be conceivable. For example, the sample could alternatively or additionally also be destained. That means that a specific fluorescent dye is removed.

Box 910 involves capturing one or a plurality of microscope images, each having a non-specific contrast. If fluorescent labels are used, for this purpose light is typically used to excite the fluorescence of the fluorescent dyes used to stain the sample in one or more previous iterations of box 905. Auto-fluorescence can also be used.

If a plurality of microscope images are captured in box 910, they can be captured using different optical channels, and may thus have a lateral offset, distortions and/or rotations, etc., with respect to one another. For example, beam splitters or filters may cause an image offset upon being changed. The optics may also have slightly different magnification scales for different colours; or other chromatic aberrations are possible.

The plurality of microscope images can be part of a multi-channel recording. That means that in principle the same optical channel is used in each case; and just e.g. a colour filter is altered between the capture of each microscope image.

It would be possible for the microscope images to be so-called mosaic images: a respective tile scan is carried out and the individual tiles are combined.

Box 915 involves capturing image data which correspond to a reference microscope image or on the basis of which it is subsequently possible to determine the reference microscope image.

For example, the reference microscope image can be part of the same multi-channel recording for which one or a plurality of microscope images are captured in box 905 in the same iteration 904. For example, the reference microscope image can be part of the same tile scan used in the same iteration 904 to capture one or a plurality of microscope images in box 905.

For example, a hardware-based phase contrast could be captured. Then, in box 915, the reference microscope image can be captured directly with this phase contrast, for example a Zernike phase contrast or a Normarski phase contrast. Other examples include a brightfield contrast or a darkfield contrast or an autofluorescence contrast. However, it would also be possible for a plurality of intensity images to be captured in box 915, each in conjunction with different defocus values and/or different illumination geometries (contrast as a result of oblique illumination). On the basis of such temporary reference microscope images, the reference microscope image can then be determined later with a digital phase contrast or a digital phase gradient contrast. That means that the temporary reference microscope images are processed further in order to obtain the (final) reference microscope image. Details are explained further below in association with box 925.

In some examples, it would be conceivable—as already explained above—for the (reference) microscope images captured in box 910 and/or in box 915 to be composed of a plurality of tiles, i.e. to be mosaic images. It is possible here for the microscope used for capturing the microscope images to have a motorized sample holder. For example, a motorized microscope stage could be used, which can be moved translationally in two or three dimensions, for example. In such a case, a respective tile image (for example a multi-channel image) is captured at a specific position of the motorized sample holder; then the motorized sample holder is moved into the next position and a further respective tile image (for example a multi-channel image) is captured in this next position. This is repeated until a predefined sample region is covered by the tile images. The different tile images can each have an overlap with respect to one another, so that a registration between adjacent tile images is possible in the overlap. The resulting microscope image can then be combined from the tile images (so-called “stitching”), i.e. is a mosaic image. A description has been given above of a scenario in which a plurality of microscope images are captured in a common tile scan; that means, therefore, that the different tile images are each multi-channel recordings. In other examples, it would be conceivable even in one iteration 904—that is to say for one staining cycle—to carry out a plurality of tile scans consecutively in order to capture different microscope images with specific contrasts and/or non-specific contrasts. It has been observed that, especially when using different tile scans for capturing different microscope images, there may be a significant offset and/or a rotation between the microscope images of the different tile scans. Box 920 involves determining whether further staining or destaining or some other manipulation of the sample is intended to be carried out. That means determining whether a further staining cycle is intended to be carried out. If further staining or destaining is intended to be carried out, a further iteration 904 of box 905 is carried out. Afterwards, it is possible to capture one or more further microscope images with the corresponding further specific contrast or the corresponding further specific contrasts in box 910 and, if appropriate, to capture one or more further reference microscope images in box 915.

If microscope images are captured in different iterations 904, they have a temporal offset with respect to one another (no common temporal context); such a temporal offset can translate into a lateral offset between the corresponding captured microscope images by way of various temporal drifts. In addition, the sample has been processed in the meantime, and so the appearance of the sample may also vary.

In principle, it is not necessary to execute box 915 in every iteration 904. For example, it would be conceivable for data for the reference microscope image to be captured in box 915 only in the first iteration 904—i.e. in one staining cycle—but not in further iterations. It would also be conceivable for a plurality of iterations 904 to be carried out with box 915, so that as a result a plurality of reference microscope images are obtained, each of which is used for the registration vis-à-vis other iterations of microscope images with specific contrast.

FIG. 3 illustrates techniques in connection with the capture of microscope images. In the various examples described here, it would in principle also be conceivable for the various microscope images already to have been captured at an earlier time and to be stored in a database. In this respect, the method from FIG. 3 is in principle optional.

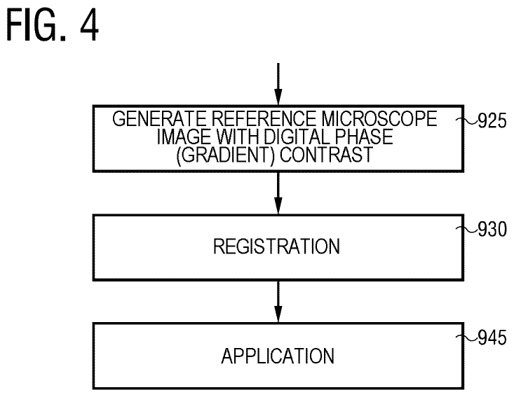

FIG. 4 is a flowchart of one exemplary method. The method from FIG. 4 can be carried out by an electronic data processing device. By way of example, the method from FIG. 4 can be executed by a processor when the latter loads program code from a memory and executes it. The method from FIG. 4 is thus computer-implemented.

The method from FIG. 4 is used to register a first microscope image with a second microscope image. The first microscope image has for example a first specific contrast, which is different from a second specific contrast of the second microscope image.

For example, the first and second microscope images and one or more reference microscope images can be captured by means of a method from FIG. 3. In this respect, the method from FIG. 4 can follow the method from FIG. 3 or else can be carried out such that in part it temporally overlaps the method from FIG. 3.

Box 925 involves optionally generating one or more reference microscope images with digital phase contrast or digital phase gradient contrast (if these are not yet present). For example, it would be conceivable for a plurality of temporary reference microscope images captured in an iteration 904 of box 915 (cf. FIG. 3) to be combined with one another. Techniques such as those known in connection with DPC or TIE can be used for this purpose. Pixelwise difference formation could also be effected in order to obtain a corresponding reference microscope image with phase gradient contrast. If the reference microscope image with phase contrast was previously captured directly in box 915, it is unnecessary to execute box 925.

It is not necessary in all variants for one or more reference microscope images with phase-like contrast to be available. Other types of non-specific contrasts can also be used. In particular, label-free contrasts can be used. Examples—besides a phase-like contrast such as e.g. a phase contrast—also include brightfield contrast, contrast as a result of oblique illumination, darkfield contrast and autofluorescence contrast.

Box 930 involves carrying out a registration between the first microscope image and the second microscope image. The registration is carried out here using one or more reference microscope images having a non-specific contrast.

In box 945, it is then possible optionally to implement an application on the basis of the registration of the first microscope image with the second microscope image. For example, the sample could be evaluated on the basis of comparisons between the first microscope image and the second microscope image taking into account the corresponding registration parameter values. For example, an ROI could be marked in one of the microscope images and then displayed in the other microscope image—taking into account the registration. Co-localization and quantification of the label concentration can be carried out to quantify the progression of a disease. A plurality of microscope images (e.g. those captured in a common temporal context) can be merged to form a multi-channel image.

It would also be conceivable, however, to carry out a stitching of the first and second microscope images (which are then tile images). In such a case, the first microscope image and the second microscope image typically have the same specific contrast. Stitching expands the field of view. A mosaic image is obtained. For this purpose, the first microscope image and the second microscope image different regions of the sample, but with an overlap. If the first microscope image and the second microscope image are registered with one another, an accurate alignment of the two microscope images can be effected as part of the stitching.

Details in connection with the determination of registration parameter values in box 930 will be discussed next. Different registration algorithms can be used to determine the registration parameter values. For example, an elastic registration algorithm could be used. It would also be conceivable to use a landmark-related registration algorithm. In particular, it is useful if registration algorithms that can handle differences in the appearance of the sample in the different microscope images are used in box 930. For example, it would be conceivable for the brightness histogram of those images which are compared with one another to be inverted. In other words, that means, therefore, that particular structures which appear bright in the microscope image with the specific contrast, for example, appear dark in the reference microscope image (and vice versa). A corresponding registration should be robust vis-à-vis both local and global inversions of the brightness histogram. Furthermore, it is useful for the first registration parameter values and/or the second registration parameter values to be determined with a multimodal registration algorithm. Such a multimodal registration algorithm is different from a unimodal registration algorithm. Unimodal registrations are typically used to align images that have a common modality; for example two absorption images recorded at wavelengths that are close together. However, since a microscope image with specific contrast is compared with the reference microscope image with non-specific contrast, a multimodal registration algorithm can yield better results: While unimodal registration algorithms can use simple metrics (e.g. least squares) as a figure of merit for the alignment of the channels with one another, multimodal registration algorithms are computationally more complex. This is owing to the fact that the similarity measure between the images to be aligned must withstand the multimodality. For example, as already described above, the brightness histograms may be locally inverted (fluorescence: dark background, brightfield/phase: bright/grey background). Typical similarity measures for multimodal registration algorithms that can be used according to the examples disclosed herein are listed in TAB. 1.

TABLE 1
Various similarity measures that enable
a multimodal registration algorithm.

| | |
|---|---|
| 1 | Mutual information |
| 2 | Normalized gradient field |
| 3 | Structural similarity index |
| 4 | Segmentation-based similarity measures |
| 5 | Feature detection |
| 6 | Artificial neural network |

First of all, “mutual information” according to TAB. 1, Example 1 will be explained. Let it be assumed that image A is a given image with greyscale levels and image B is a second image with greyscale levels, which in the most general case is in a non-linear relationship with image A. Without restricting generality, the functional relationship B=1−A² can be used. If all value pairs of pixels (Aₖ|Bₖ) are formed, where k is a linear pixel index, and are represented in relation to one another in a two-dimensional coordinate system, the non-linear functional relationship B=1−A² becomes visible. In particular, such a non-linear relationship makes it possible to apprehend for example that bright pixels in image A appear dark in image B, and vice versa (that corresponds to the brightness histogram inversion). That means that there is a rule according to which the pixel greyscale value in image B can be predicted if the corresponding pixel greyscale value in image A is known. It will now be assumed that the image A is slightly displaced relative to the image B: If the image B is displaced one pixel to the right, the simple functional relationship is disturbed. The correspondence between the image A and the displaced image B has become more complicated. It is no longer possible simply to predict what the greyscale value of image B is if the greyscale value of image A is known. The predictability of a second image from a first image can be quantified using the mathematical concept of mutual information. This is done by firstly forming the relative frequencies at which a pixel in image A assumes the greyscale value a and at the same time a corresponding (identical linear index k) pixel in image B assumes the greyscale value b. If the relative frequencies at which images A and B respectively assume the greyscale values a and b are expressed by bivariate probabilities p_{A,e}(a,b), then the mutual information (MI) is mathematically defined by the expression

$$MI = {\sum }_{a , b} {p}_{A , B} ( a , b ) \cdot log ( \frac{{p}_{A , B} ( a , b )}{{p}_{A} ( a ) {p}_{B} ( b )} )$$

where the univariate probabilities p_{A}(a)=Σ_{b}p_{A,B}(a,b) and p_{B}(b)=Σₐp_{A,B}(a,b) can be calculated directly from the bivariate probability by marginalization. Consequently, two multimodal images are aligned with one another if their mutual information is maximal. This principle makes it possible to register images with respect to one another by displacing or rotating them three-dimensionally relative to one another until their mutual information is maximized.

TAB. 1, Example 2 “normalized gradient field” (NGF) will be explained next. While multimodal images for identical structures may have different brightness values, the corners and edges thereof ought to be superimposed in the aligned state. A corresponding measure that uses this observation for the alignment of images was described by Haber and Modersitzki (Haber, Eldad, and Jan Modersitzki. “Intensity gradient based registration and fusion of multi-modal images.” Methods of information in medicine 46.03 (2007): 292-299.) and is referred to here as normalized gradient field, NGF. The normalized gradient field for image A is described by

$$n ( A , x ) = \frac{∇ A ( x )}{{‖ ∇ A ( x ) ‖}_{2}}$$

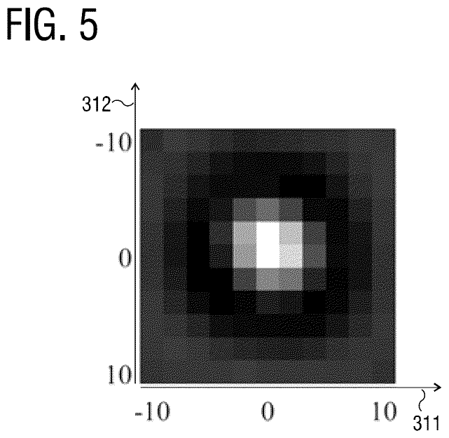

and analogously for image B. The following distance functional, D (A,B), can then be maximized with displacement of one image in comparison with the next in order to align the images A and B with one another:

$$D ( A , B ) = \int {‖ n ( A , x ) \times n ( B , x ) ‖}_{2} dx$$

where the operation x represents the cross product of the vector fields n(A,x) and n(B,x)∥ . . . ∥₂ is the root of the componentwise squares of the calculated cross product. By way of example, FIG. 5 shows the registration parameter values 311, 312 of the translational displacement in the x-direction and y-direction (in units of image pixels) for two microscope images having different fluorescence contrasts, each in relation to a TIE phase contrast image. The image displacement can be calculated by ascertaining the maximum of the function D(A,B). The registration based on the “NGF registration algorithm” requires less than 1.7 seconds in practical examples on a commercially available notebook, while a registration algorithm with mutual information similarity measure required 14.5 seconds in the computation (with identical computing hardware). The NGF registration algorithm is thus preferable to the mutual information-based registration algorithm for performance reasons. In particular, subpixel displacements can be attained by regression of a suitable second degree polynomial or a Gaussian function. By estimating the parameters of the polynomial or Gaussian function, the maximum is known with subpixel accuracy.

For segmentation-based similarity according to TAB. 1, Example 4, for example particular structures, i.e. e.g. cells, are masked: Where yeast cells are present, the masked image acquires the value 1, and where they are not present, the image acquires the value 0. By means of segmentation, multimodal images can be converted into unimodal images: both the microscope images with fluorescence contrast and the reference microscope image become binary images of the same modality by means of segmentation. After segmentation into binary images, therefore, conventional unimodal similarity measures such as the least squares distance can be used for registration.

According to TAB. 1, Example 6, artificial neural networks can be used to merge together images with different contrast types. In the context of microscopy this is referred to as virtual staining (see e.g. WO 2021/198 241 A1) or image2image learning. For this purpose, UNET or cycleGAN architectures are mainly used for the artificial neural network. Consequently, for example a phase image (as a reference microscope image) can be converted into a virtual fluorescence image. The other fluorescence channels can then be registered with the virtual fluorescence image unimodally.

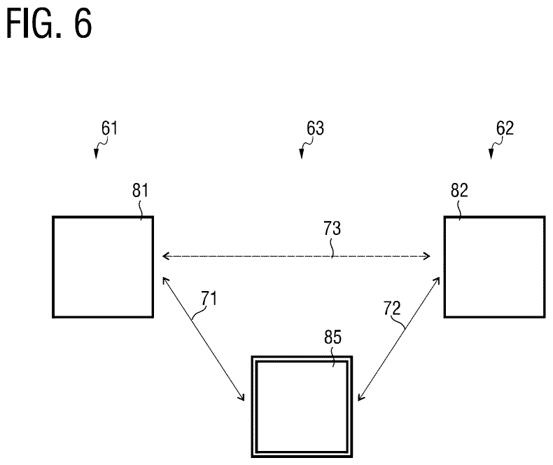

FIG. 6 schematically illustrates a first microscope image 81 with a first specific contrast and a second microscope image 82 with a second specific contrast.

The microscope images 81, 82 could be e.g. tile images or mosaic images. The mosaic images 81, 82 can at least partially overlap one another. Typically, the degree of overlap is greater for mosaic images than for tile images.

For example, the two microscope images 81, 82 could be captured using different optical channels and/or in separate temporal contexts (for example in different iterations 904 in FIG. 3). That means that between the two microscope images 81, 82, a lateral displacement and/or rotation and/or distortion, etc. may be present. FIG. 6 illustrates that the two microscope images 81, 82 are captured using different optical channels 61, 62.

Moreover, FIG. 6 also schematically illustrates a reference microscope image 85, which is captured using a third optical channel 63. Thus, a lateral displacement, rotation, distortion, etc. may also be present between the reference microscope image 85 and the microscope image 81 and between the reference microscope image 85 and the microscope image 82. For example, the reference microscope image 85 could be captured in the same iteration 904 (cf. FIG. 3) as the microscope image 81.

FIG. 6 illustrates that first registration parameter values 71 are determined on the basis of a comparison of the microscope image 81 with the reference microscope image 85; in addition, second registration parameter values 72 are determined on the basis of a further comparison, namely between the microscope image 82 and the reference microscope image 85. In order that a registration of the microscope image 81 with the microscope image 82 then also takes place, the registration parameters 71 and the registration parameters 72 could be explicitly concatenated (or generally combined) with one another in order to obtain further registration parameters 73, which mediate directly between the two microscope images 81, 82.

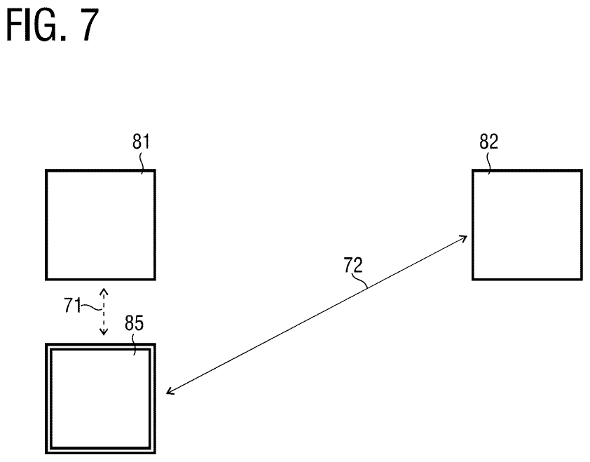

FIG. 7 illustrates one variant of FIG. 6. The reference microscope image 85 and the microscope image 81 here are part of the same multi-channel recording (and are mosaic images, for example). The optical channel of the reference microscope image 85 and the optical channel of the microscope image 81 are particularly similar (for example, the two optical channels may differ just in terms of a colour filter used); therefore, the reference microscope image 85 and the microscope image 81 are inherently registered and corresponding registration parameter values 71 do not need to be separately determined by a comparison between the microscope image 81 and the reference microscope image 85. On the other hand, a comparison between the reference microscope image 85 and the second microscope image 82 can be effected for determining the registration parameter values 72 (the microscope image 82 is not part of the multi-channel recording).

In some examples, however, the registration parameter values 71 can also be determined by a comparison of the reference microscope image 85 with the first microscope image 81; for example if chromatic aberrations are present on account of different colour filters used, which cause a lateral offset, compression, rotation, etc. of the microscope images 81, 85 captured at different wavelengths.

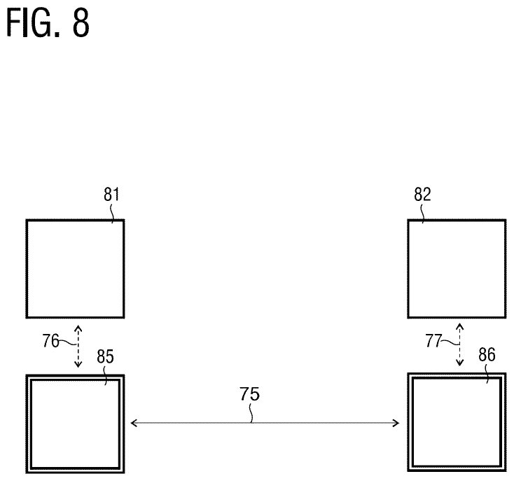

FIG. 8 illustrates yet another variant of FIG. 6. That involves capturing reference microscope images 85, 86 with the non-specific contrast, which are each inherently registered with the respective microscope image 81, 82. For example, the microscope image 81 and the reference microscope image 85 can be part of the same multi-channel recording; in addition, the microscope image 82 and the reference microscope image 86 can be part of the same multi-channel recording. The two reference microscope images 85, 86 could be captured for example in respective staining cycles or iterations 904 in which the respectively associated microscope image 81, 82 is captured. By comparing the reference microscope images 85, 86 with one another, it is possible to determine corresponding registration parameter values 75 which correspond to a registration of the two microscope images 81, 82. Merely optionally (for example if significant chromatic aberrations are present), it is possible to determine even further registration parameter values 76, 77 in each case between the microscope images 81, 82 and the associated reference microscope images 85, 86 by means of corresponding comparisons. For the comparison between the reference microscope images 85, 86, a unimodal registration algorithm can typically be used; whereas for a comparison between the microscope image 81 and the reference microscope image 85, for example, a multimodal registration algorithm should be used.

It would in principle be conceivable (but not necessary) for the microscope image 81, the microscope image 82 and also the reference microscope image 85 and/or the reference microscope image 86—as discussed above in connection with the various figures—all to be parts of a common multi-channel recording.

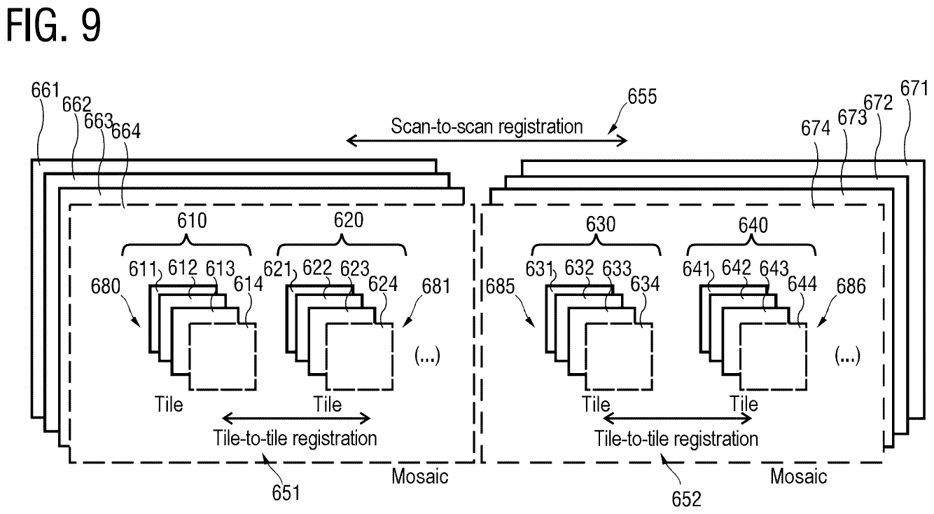

In the various examples described herein, registrations can be effected at different stages of image processing. At a first stage, the registration between different tile images of a tile scan can be effected. These tile images can subsequently be combined to form a mosaic image using this registration. At a second stage, a registration of different mosaic images (e.g. from different staining cycles) can then be effected. A corresponding technique is shown in FIG. 9.

FIG. 9 illustrates aspects of a two-stage registration. FIG. 9 shows that in a first staining cycle (cf. FIG. 3: iterations 904) a multi-channel recording 610 is captured for a first tile 680 and a further multi-channel recording 620 is captured for a further tile 681. In this case, the multi-channel recording 610 in the example illustrated comprises four channels, that is to say three microscope images 611-613 with specific contrast; and a reference microscope image 614 with non-specific contrast. The multi-channel recording 620 in turn has the same four channels, that is to say corresponding microscope images 621-624 with the same specific contrasts as the corresponding microscope images 611-613; and a further reference microscope image 624 having the same non-specific contrast as the reference microscope image 614. A respective reference microscope image is captured for each tile position of each tile scan.

Instead of multichannel recordings for each tile—as shown in FIG. 9—it would also be possible to carry out a separate tile scan for each contrast. That means that e.g. the microscope images 611, 612 are captured in a first tile scan; and the microscope images 612, 622 are captured in a second tile scan; and the microscope images 613, 623 are captured in a third tile scan. The second tile scan is started after completion of the first tile scan, and so on. The reference contrast can then be recorded only for one tile scan or even for each tile scan.

The two multi-channel recordings 610, 620 are captured in a common tile scan. That means that the microscope images 611-614 and the microscope images 621-624 image different regions of the sample (the sample stage is moved therebetween), but have an overlap. On the basis of the overlap, e.g. the microscope image 611 can be registered with the corresponding microscope image 621 (tile-to-tile registration 651). For example, if the microscope image 611 is intended to be registered with the microscope image 621, this can be done as shown in FIG. 8.

In detail, the microscope image 611 can be aligned with the reference microscope image 614, for example by means of a multimodal registration algorithm (cf. FIG. 8: registration parameter values 76); moreover, the microscope image 621 can be aligned with the reference microscope image 624 (cf. FIG. 8: registration parameter values 77), for example by means of the same multimodal registration algorithm. However, this would only be necessary if the microscope image 611 and the reference microscope image 614 are not inherently registered anyway; or if the microscope image 621 and the reference microscope image 624 are not inherently registered anyway. Moreover, it is possible to carry out a further unimodal registration algorithm for registering the reference microscope image 614 with the reference microscope image 624 (registration parameter values 75) in order to align the reference microscope image 614 with the reference microscope image 624 in the overlap region. As a result, a registration of the microscope image 611 with the microscope image 621 is obtained, so that these can be accurately stitched. This is a first stage of registration.

The first stage of registration, i.e. a further tile-to-tile registration 652, can also be effected for microscope images 631-633 of a tile 685 and microscope images 641-643 of a tile 686. For this purpose, the corresponding multi-channel recordings 630, 640 each have a reference microscope image 634, 644 with non-specific contrast. The multi-channel recording 630 thus comprises four channels, that is to say three microscope images 631-633 with different specific contrasts; and a reference microscope image 634 with a non-specific contrast.

Typically, different specific contrasts are used in the different staining rounds. For example, it would be conceivable to use one or more non-fluorescent labels in the first staining round in order to capture corresponding specific contrasts. One or more fluorescent labels could then be used in the second staining round.

It is also not necessary for the different multi-channel recordings to have the same number of channels in different staining rounds. For example, in a first staining round, multi-channel recordings could be recorded with two channels, for example a H&E contrast (specific contrast) and digital phase contrast (non-specific contrast). In a second staining round, multi-channel recordings can then be recorded with three or more channels, for example with different fluorescence contrasts and the digital phase contrast.

As a result, in the example in FIG. 9, a corresponding mosaic microscope image 661-663 is obtained for each specific contrast captured in this tile scan (that is to say a total of three specific contrasts) by means of the tile-to-tile registration 651; and a corresponding mosaic microscope image 671-673 is obtained for each specific contrast captured in this tile scan by means of the tile-to-tile registration 652. Moreover, in FIG. 9, two mosaic reference microscope images 664, 674 are also obtained, one for each of the two tile scans. It is then possible to register these mosaic microscope images 661-663, 671-673 (which, as described above, are already registered with the respective mosaic reference microscope images) with one another: that is the scan-to-scan registration 655. This can be done for example by means of a unimodal registration algorithm which registers the two mosaic reference microscope images 664, 674 with one another. The use of the unimodal registration algorithm is expedient especially if the two mosaic reference microscope images have the same and specific contrast.

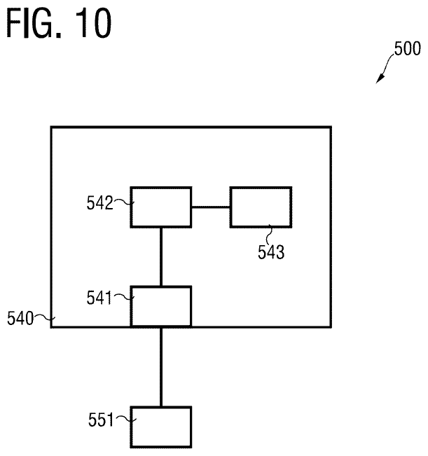

FIG. 10 schematically illustrates a system 500. The system 500 comprises an electronic data processing device 540. The electronic data processing device 540 can be for example a “personal computer” (PC). The electronic data processing device 540 comprises a processor 542 and a memory 543. The electronic data processing device 540 also comprises a communication interface 541. For example, the processor 542 can receive image data for microscope images via the communication interface 541. For example, the processor 542 could receive the image data from a microscope 551, or an external image database (not shown in FIG. 10). However, the processor 542 could also load the image data from the memory 543 and execute them. The processor 542 could transmit control instructions to the microscope 551, which trigger the capture of microscope images and/or set a specific illumination geometry and/or a specific defocus value (e.g. for TIE or DPC or mixtures thereof). The processor 542 can load program code from the memory 543 and execute it. When the processor executes such program code, this has the effect that the processor 542 executes techniques such as are described herein, for example: determining registration parameter values by comparing microscope images; determining registration parameter values by combination of other registration parameter values; controlling the microscope 551 to capture microscope images with and without fluorescence contrast; determining microscope images with a phase contrast or a phase gradient contrast; etc.

In summary, a description has been given above of techniques for mediating a registration between two microscope images with different fluorescence contrasts (or generally different specific contrasts) via a reference microscope image without specific contrast. For example, a digital phase contrast image (e.g. with TIE or DPC) can be used as reference for two- or three-dimensional co-registration of fluorescence channels. This is relevant because microscope images with different fluorescence contrasts may have a lateral offset on account of filters and beam splitters that are not perfectly adjusted, and an axial offset on account of chromatic aberrations. Furthermore, some microscopes operate in a mode that involves firstly capturing all tiles per channel. That means that a sample with lateral and axial offsets is scanned completely for each fluorescence contrast before the next fluorescence channel is measured. This mode is advantageous in order to minimize mechanical wear on filter and beam splitter wheels. However, the multidirectional repetition accuracy of the mechanical sample scanner is limited, which may cause further displacements between the microscope images with different fluorescence contrast. Furthermore, the fact that various non-specific contrasts can be used has been described above. In this regard, a phase gradient contrast could also be used instead of a digital phase contrast for the reference microscope image. A phase gradient contrast can be generated in a particularly computationally efficient manner, namely by calculating pixelwise difference formation between two intensity images captured in conjunction with different illumination geometries, for example.

Moreover, a description has been given of techniques in which a multimodal registration algorithm is used to register a microscope image with a specific contrast and a reference microscope image with non-specific contrast with one another. These can be tile images from different tile scans or else from a common multi-channel recording. In particular, techniques using an NGF-based registration algorithm have been described. Such an NGF-based multimodal registration algorithm is particularly performant and can be implemented computationally efficiently even with limited computer hardware.

An elastic multimodal registration algorithm can be used. An elastic registration can also take into account non-linear differences between an image pair, for example deformations or distortions.

To summarize further, the following EXAMPLES, in particular, have been disclosed.

EXAMPLE 1. Computer-implemented method for registering a first microscope image (81, 91) with a second microscope image (82, 92), wherein the first microscope image images a sample with a first specific contrast, wherein the second microscope image images the sample with the first specific contrast or a second specific contrast,
wherein the method comprises:
   obtaining a reference microscope image (85, 86, 99), which images the sample with a non-specific contrast such as for example a phase-like contrast, and
   carrying out the registration of the first microscope image with the second microscope image using the reference microscope image.

EXAMPLE 2. Computer-implemented method according to EXAMPLE 1, wherein carrying out the registration of the first microscope image and the second microscope image comprises:
determining (930) registration parameter values (72, 311, 312) for the registration on the basis of a comparison of the second microscope image (92, 82) with the reference microscope image (85, 99).

EXAMPLE 3. Computer-implemented method according to EXAMPLE 2, wherein carrying out the registration of the first microscope image and the second microscope image comprises:
determining (935) further registration parameter values (71, 311, 312) for the registration on the basis of a comparison of the first microscope image (91) with the reference microscope image (85, 99) or a further reference microscope image, which images the sample with the non-specific contrast.

EXAMPLE 4. Computer-implemented method according to EXAMPLE 3, wherein carrying out the registration of the first microscope image and the second microscope image comprises:
on the basis of a combination of the registration parameter values (72, 311, 312) and the further registration parameter values (71, 311, 312), determining (940) result registration parameter values for the registration of the first microscope image (91) with the second microscope image (92).

EXAMPLE 5. Computer-implemented method according to any of the preceding EXAMPLES, wherein the method furthermore comprises:
obtaining a further reference microscope image (86), which images the sample with the non-specific contrast,
wherein carrying out the registration of the first microscope image (81, 91) and the second microscope image (82, 92) comprises:
determining registration parameter values (75) for the registration on the basis of a comparison of the reference microscope image (85) with the further reference microscope image (86).

EXAMPLE 6. Computer-implemented method according to EXAMPLE 5, wherein carrying out the registration of the first microscope image and the second microscope image comprises:
determining further registration parameter values (76) for the registration on the basis of a comparison of the first microscope image (81) with the reference microscope image (85) and/or
determining further registration parameter values (77) for the registration on the basis of a comparison of the second microscope image (82) with the further reference microscope image (86).

EXAMPLE 7. Computer-implemented method according to any of EXAMPLES 1 to 6,
wherein the reference microscope image and the first microscope image are part of the same multi-channel recording and wherein the reference microscope image and the second microscope image are not part of the same multi-channel recording, and/or
wherein the sample is manipulated between the capture of the first microscope image and the capture of the second microscope image.

EXAMPLE 8. Computer-implemented method according to any of EXAMPLES 1 to 6,
wherein the first microscope image and the second microscope image and optionally also the reference microscope image are part of the same multi-channel recording and wherein the sample is not manipulated between the capture of the first microscope image and the capture of the second microscope image.

EXAMPLE 9. Computer-implemented method according to any of the preceding EXAMPLES,
wherein the phase-like contrast is selected from the following group: a phase contrast; a digital phase contrast; a digital phase gradient contrast.

EXAMPLE 10. Computer-implemented method according to any of the preceding EXAMPLES, wherein the method furthermore comprises:
obtaining a first temporary reference microscope image and a second temporary reference microscope image, wherein the first temporary reference microscope image and the second temporary reference microscope image both image the sample with the same intensity contrast and different defocus values, and
determining the reference microscope image on the basis of pixelwise difference formation between the first temporary reference microscope image and the second temporary reference microscope image.

EXAMPLE 11. Computer-implemented method according to any of the preceding EXAMPLES,
wherein registration parameter values of the registration are determined by a registration algorithm that determines a similarity measure between the respective microscope image pair on the basis of a metric that is robust vis-à-vis a brightness histogram inversion in the microscope image pair, and/or
wherein registration parameter values of the registration are determined by a multimodal registration algorithm.

EXAMPLE 12. Computer-implemented method according to any of the preceding EXAMPLES,
wherein registration parameter values of the registration are determined by a registration algorithm selected from the following group: mutual information; normalized gradient field; structural similarity index; segmentation-based similarity measure; feature detection; and artificial neural network.

EXAMPLE 13. Computer-implemented method according to any of the preceding EXAMPLES,
wherein registration parameter values of the registration are determined by an elastic registration algorithm, and/or
wherein registration parameter values of the registration are determined by a landmark-related registration algorithm.

EXAMPLE 14. Computer-implemented method according to any of the preceding EXAMPLES, wherein the method furthermore comprises:
carrying out a stitching of the first microscope image and the second microscope image on the basis of the registration.

EXAMPLE 15. Electronic data processing device (540) configured for registering a first microscope image (81, 91) with a second microscope image (82, 92), wherein the first microscope image images a sample with a first specific contrast, wherein the second microscope image images the sample with the first specific contrast or a second specific contrast,
wherein the electronic data processing device comprises a processor and a memory, wherein the processor is configured to load program code from the memory and execute it, and wherein the processor, when the program code is executed, executes the following steps:
   obtaining a reference microscope image (85, 86, 99), which images the sample with a non-specific contrast, and
   carrying out the registration of the first microscope image with the second microscope image using the reference microscope image.

EXAMPLE 16. Electronic data processing device according to EXAMPLE 10, wherein the processor, when the program code is executed, executes the method according to any of EXAMPLES 1 to 14.

It goes without saying that the features of the embodiments and aspects of the invention described above can be combined with one another. In particular, the features can be used not only in the combinations described but also in other combinations or on their own, without departing from the scope of the invention.

For example, a description has been given above of techniques in which two-dimensional images are processed and registered. In principle, however, all the techniques described can also be used for three-dimensional images in order to correct lateral and axial translation errors (alignment of mutually displaced focus stacks or longitudinal chromatic aberrations), scaling errors (varying pixel size of the camera or variable objective magnification), and also rotation errors (camera rotation).

Furthermore, a description has been given above of techniques which involve capturing microscope images with specific contrasts for samples. The samples can be cell or tissue samples, for example.

1. Computer-implemented method for registering a first microscope image with a second microscope image, wherein the first microscope image images a sample with a first specific contrast, wherein the second microscope image images the sample with the first specific contrast or a second specific contrast,
wherein the method comprises:
obtaining a reference microscope image, which images the sample with a non-specific contrast, and
carrying out the registration of the first microscope image with the second microscope image using the reference microscope image.

2. The computer-implemented method according to claim 1,
wherein carrying out the registration comprises applying a multimodal registration algorithm,
wherein the non-specific contrast is a label-free contrast that is selected from the following group: phase-like contrast; phase contrast; brightfield contrast; contrast as a result of oblique illumination; darkfield contrast; autofluorescence contrast.

3. The computer-implemented method according to claim 2,
wherein the first microscope image is associated with a first staining cycle of the sample,
wherein the second microscope image is associated with a second staining cycle of the sample.

4. The computer-implemented method according to claim 3,
wherein the reference microscope image is associated with the first staining cycle of the sample,
wherein the method furthermore comprises:
obtaining a further reference microscope image, which images the sample with the non-specific contrast and which is associated with the second staining cycle,
wherein carrying out the registration comprises:
comparing the reference microscope image with the further reference microscope image.

5. The computer-implemented method according to claim 4,
wherein carrying out the registration furthermore comprises:
comparing the first microscope image with the reference microscope image, and/or
comparing the second microscope image with the further reference microscope image.

6. The computer-implemented method according to claim 4,
wherein the first microscope image and the reference microscope image are inherently registered, and/or
wherein the second microscope image and the further reference microscope image are inherently registered.

7. The computer-implemented method according to claim 4,
wherein the first microscope image is a first mosaic image, which is composed of first tile images,
wherein the second microscope image is a second mosaic image, which is composed of second tile images,
wherein the multimodal registration algorithm is applied between the first tile images and respective reference tile images of the reference microscope image and also between the second tile images and respective further reference tile images of the further reference microscope image,
wherein carrying out the registration furthermore comprises applying a unimodal registration algorithm between the reference microscope image and the further reference microscope image.

8. The computer-implemented method according to claim 3,
wherein the reference microscope image is associated with the first staining cycle of the sample,
wherein carrying out the registration comprises:
comparing the second microscope image with the reference microscope image.

9. The computer-implemented method according to claim 8,
wherein the first microscope image and the reference microscope image are inherently registered.

10. The computer-implemented method according to claim 1,
wherein the first microscope image is a first tile image of a tile scan, wherein the second microscope image is a second tile image of the tile scan, which has a partial overlap with the first tile image,
wherein the reference microscope image is a third tile image of the tile scan.

11. The computer-implemented method according to claim 10,
wherein a corresponding reference microscope image is available for each tile position of the tile scan.

12. Electronic data processing device having a processor and a memory, wherein the processor is configured to load program code from the memory and execute it, wherein the processor, on the basis of the execution of the program code, is configured to obtain a reference microscope image, which images the sample with a non-specific contrast, and to carry out a registration of a first microscope image with a second microscope image using the reference microscope image, wherein the first microscope image images a sample with a first specific contrast, wherein the second microscope image images the sample with the first specific contrast or a second specific contrast.

13. The electronic data processing device according to claim 12, wherein the processor, on the basis of the execution of the program code, is configured to when carrying out the registration comprises applying a multimodal registration algorithm, and wherein the non-specific contrast is a label-free contrast that is selected from the following group: phase-like contrast; phase contrast; brightfield contrast; contrast as a result of oblique illumination; darkfield contrast; autofluorescence contrast.
